(19) United States
(12) Patent Application Publication
(10) Pub. No.: US 2007/0086156 A1
(43) Pub. Date: Apr. 19, 2007

(54) Protective data storage caddy

(76) Inventor: David Norton Skinner, Redwood Shores, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/252,416

(22) Filed: Oct. 17, 2005

(51) Int. Cl. G06F 1/16

(52) U.S. Cl. 361/685; 248/633; 369/80

(57) ABSTRACT

A hard drive caddy for protecting a hard disk drive (HDD) and connecting to a host system is described. The hard drive caddy includes a housing, which defines a compartment of an appropriate size for receiving the HDD. The housing also serves to protect the exposed components of said HDD. The hard drive caddy also includes a connector, within the housing, to interface with the HDD, and a second connector to interface with the host system. The hard drive caddy also includes a mechanism to hold the HDD securely within the compartment.

### TECHNICAL FIELD

Embodiments of the present invention relate to devices to protect digital data storage devices from damage while allowing for normal or enhanced functionality.

### BACKGROUND ART

At present, consumers have few options for physically transporting large quantities of data. Modern media applications involve storage requirements that would have been unthinkable in the recent past. A standard-sized floppy is not suitable for any multimedia purpose, and modem computer systems often lack a floppy disk drive. Writable CD-ROMs and DVDs are a somewhat better option, providing capacity sufficient for up to several hours of high-quality video data, but modem HDDs have capacities of multiple hundreds of gigabytes. To transfer that much information to writable disks would involve significant time, and produce an unwieldy stack of dozens or hundreds of disks as a final product.

If the consumer wishes to transport the contents of an entire HDD, he must transport the drive itself. However, transporting an HDD entails a number of risks, and a certain amount of inconvenience. The HDD is easily damaged or destroyed by physical means—dropping an HDD may destroy the data, and exposed components may be damaged by catching on other surfaces. The HDD is sensitive to electrical shock as well, particularly from static. Moreover, the HDD is not easily removed from a system, or inserted into another; multiple cables must be disconnected and reconnected, and screws must be removed and inserted. And the drive itself is often coarsely machined, with exposed rough or sharp edges.

In spite of these shortcomings associated with removing, transporting, and inserting the HDD, consumers have no viable alternatives if they wish to physically transport large amounts of digital data.

### DISCLOSURE OF THE INVENTION

A hard drive caddy for protecting a hard disk drive (HDD) and connecting to a host system is described. The hard drive caddy includes a housing, which defines a compartment of an appropriate size for receiving the HDD. The housing also serves to protect the exposed components of said HDD. The hard drive caddy also includes a connector, within the housing, to interface with the HDD, and a second connector to interface with the host system. The hard drive caddy also includes a mechanism to hold the HDD securely within the compartment.

### BRIEF DESCRIPTION OF THE DRAWINGS

The drawings referred to in this description should not be understood as being drawn to scale unless specifically noted. The accompanying drawings, which are incorporated in and form a part of this specification, illustrate embodiments of the invention and, together with the description, serve to explain the principles of the invention:

FIG. 1 is a representation of a hard drive caddy, in accordance with one embodiment of the present invention.

FIG. 2 is a representation of a hard drive caddy, in accordance with one embodiment of the present invention.

FIG. 3 is a representation of a hard drive caddy with customizable skins, in accordance with one embodiment of the present invention.

FIG. 4 is a block diagram of an exemplary computer system upon which embodiments of the present invention may be implemented.

FIG. 5 is a representation of a hard drive caddy interacting with a computer system, in accordance with one embodiment of the present invention.

### DETAILED DESCRIPTION OF THE INVENTION

A hard drive caddy for protecting a hard disk drive (HDD) and connecting to a host system is disclosed. Reference will now be made in detail to several embodiments of the invention. While the invention will be described in conjunction with the alternative embodiment(s), it will be understood that they are not intended to limit the invention to these embodiments. On the contrary, the invention is intended to cover alternative, modifications, and equivalents, which may be included within the spirit and scope of the invention as defined by the appended claims.

Exemplary Computer System

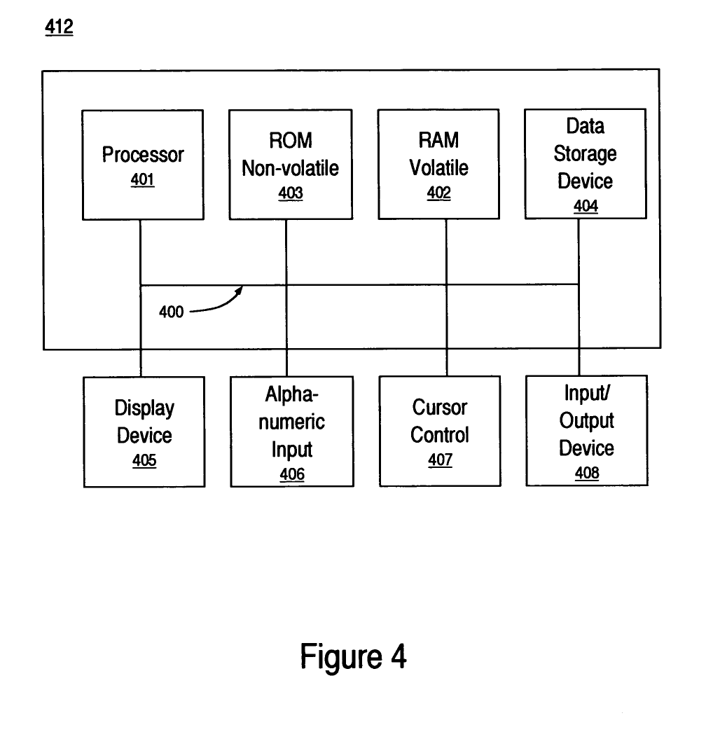

Referring now to FIG. 4, a block diagram of an exemplary computer system 412 is shown. It is appreciated that computer system 412 described herein illustrates an exemplary configuration of an operational platform upon which embodiments of the present invention can be implemented. Nevertheless, other computer systems with differing configurations can also be used in place of computer system 412 within the scope of the present invention. That is, computer system 412 can include elements other than those described in conjunction with FIG. 4. Moreover, the present invention may be practiced on any system which can be configured to allow it, not just computer systems like computer system 412.

Computer system 412 includes an address/data bus 400 for communicating information, a central processor 401 coupled with bus 400 for processing information and instructions; a volatile memory unit 402 (e.g., random access memory [RAM], static RAM, dynamic RAM, etc.) coupled with bus 400 for storing information and instructions for central processor 401; and a non-volatile memory unit 403 (e.g., read only memory [ROM], programmable ROM, flash memory, etc.) coupled with bus 400 for storing static information and instructions for processor 401. Computer system 412 may also contain an optional display device 405 coupled to bus 400 for displaying information to the computer user. Moreover, computer system 412 also includes a data storage device 404 (e.g., disk drive) for storing information and instructions.

Also included in computer system 412 is an optional alphanumeric input device 406. Device 406 can communicate information and command selections to central processor 401. Computer system 412 also includes an optional cursor control or directing device 407 coupled to bus 400 for communicating user input information and command selections to central processor 401. Computer system 412 also includes signal communication interface (input/output device) 408, which is also coupled to bus 400, and can be a serial port. Communication interface 408 may also include wireless communication mechanisms. Using communication interface 408, computer system 412 can be communicatively coupled to other computer systems over a communication network such as the Internet or an intranet (e.g., a local area network).

Structure of a Hard Drive Caddy

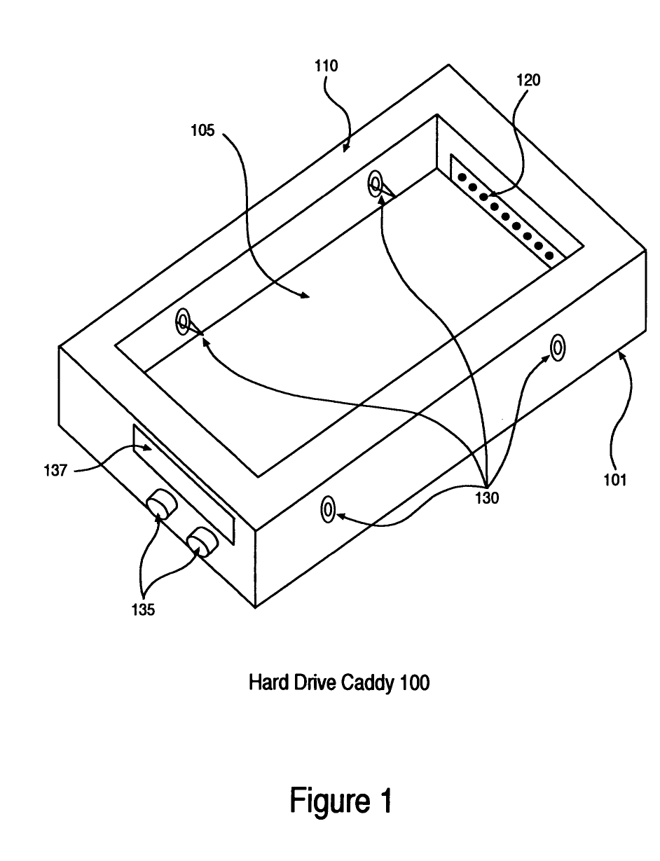

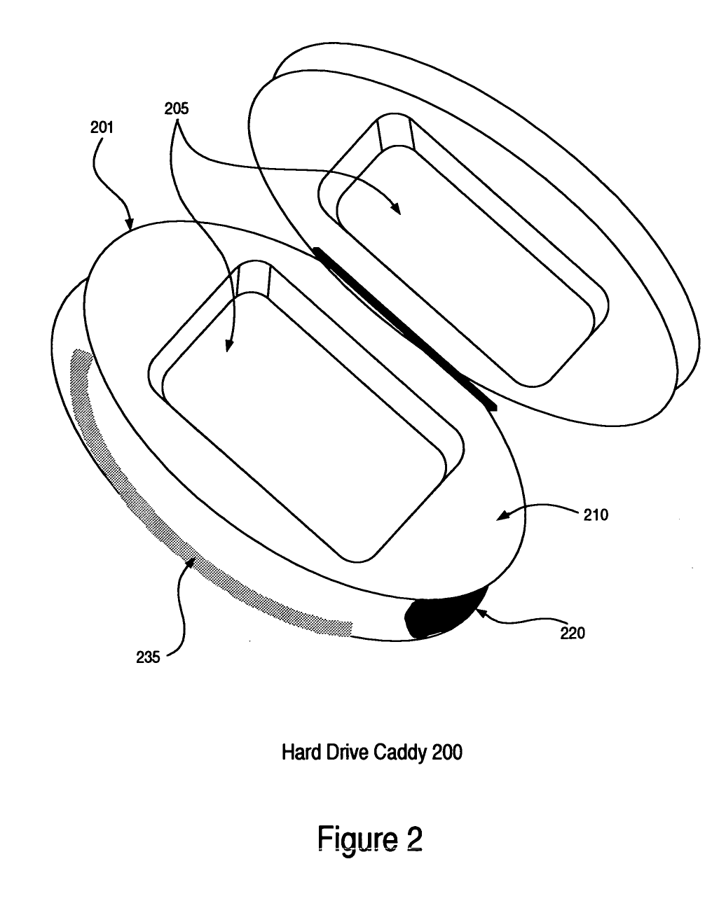

With reference now to FIGS. 1 and 2, representations of hard drive caddies are depicted, in accordance with embodiments of the present invention. In the embodiment of FIG. 1, hard drive caddy 100 has a housing 101. Housing 101 defines a compartment 105 into which a standard 3.5″ hard disk drive (HDD) (not shown) may be inserted. In this embodiment, hard drive caddy 100 also includes protective component 110, HDD connector 120, securing elements 130, optional display 135, and optional control mechanisms 137. In this embodiment, hard drive caddy 100 also includes a second connector, not shown. In the embodiment of FIG. 2, hard drive caddy 200 has a housing 201 defining a compartment 205, protective component 210, pass-through 220, and optional handle 235.

In one embodiment, housing 101 is formed of a high-strength plastic material, and is rectangular in shape. In other embodiments, other materials may be used for housing 101, such as brushed aluminum. In other embodiments, other shapes or form factors are used. One consideration in selecting a material and form-factor for housing 101 is the intended use of hard drive caddy 100. If hard drive caddy 100 is to be used with computer system 412, where computer system 412 is a media center computer, it is desirable for housing 101 to be formed of a material similar to that used for the rest of the media center components, such as a silver or black metal. If hard drive caddy 100 is to be used in conjunction with a hard drive enclosure, housing 101 should have a form factor suitable for interacting with such an enclosure.

In one embodiment, compartment 105 is of a size and shape appropriate to holding a standard 3.5″ HDD. Allowing for the use of a standard-size hard drive is advantageous, as such off-the-shelf components are less expensive than customized hardware. Further, the size, shape, and connectors for such HDDs are fully standardized, allowing for greater interoperability. In other embodiments, compartment 105 is of a size and shape appropriate to other data storage devices, e.g., laptop hard drives, or solid-state storage devices like compact flash cards. In another embodiment, housing 101 is a sleeve-like container, into which the HDD can be slid. In another embodiment, housing 201 of hard drive caddy 200 is a clamshell-like container, into which the HDD is placed, and then the upper portion can be closed on top.

In the embodiment of FIG. 1, compartment 105 does not fully enclose an HDD placed within. In other embodiments, compartment 105 encloses differing amounts of the HDD. One consideration in determining how much of the HDD compartment 105 should enclose is whether the HDD has exposed electronic components that may be damaged by leaving them exposed. Another consideration is whether the HDD has sharp edges which may damage other objects brought into contact with the HDD. In the embodiment of FIG. 2, compartment 205 completely encloses an HDD placed within.

In this embodiment, hard drive caddy 100 includes protective component 110. Protective component 110, in one embodiment, serves to provide physical protection to the HDD contained in hard drive caddy 100. Such protection includes shock absorption, to protect against accidental falls. Physical protection also includes protecting vulnerable exposed components, such as exposed printed circuit boards, which are common to standard HDDs. In one embodiment, protective component 110 is an expanded polystyrene material, and acts like a bicycle helmet for the hard drive; in such embodiments, consumers may wish to replace their hard drive caddy 110 if it is ever dropped. In another embodiment, protective component 110 is made of a visco-elastic material. In another embodiment, protective component 110 incorporates a mechanical damping or dampening element, e.g., springs. In another embodiment, protective component 110 is soft foam. In other embodiments, other compositions of protective component 110 are used. In some embodiments, combinations of materials and methods are used to provide greater protection.

In the embodiment of FIG. 2, protective component 210 provides electric protection for hard drive caddy 200 and the associated HDD. In this embodiment, protective component 210 is made of a non-conductive material, so as to prevent electric shocks from reaching the HDD within hard drive caddy 200 and thereby damaging the contents. In another embodiment, protective component 210 includes conductive material and non-conductive material, so as to provide grounding for electric shocks, rather than allow them to pass to the HDD.

In this embodiment, hard drive caddy 100 includes two connectors. Connector 120, in this embodiment, is a combination of the standard power connector and IDE interface connector used for 3.5″ IDE/EIDE HDDs. In another embodiment, connector 120 is of a type used to interface with a different data storage device, e.g., compact flash cards. A second connector, not pictured, is used to connect hard drive caddy 100 to the host system, e.g., computer system 412. In one embodiment, this second connector is of a like type as connector 120, e.g., a traditional IDE interface. In another embodiment, this second connector is a different but interface connector, e.g., Firewire or USB. In these embodiments, this pair of connectors allows the host system to communicate with the HDD in hard drive caddy 100.

In one embodiment, hard drive caddy 100 includes a number of connectors for interfacing with multiple host systems. These connectors may all be of the same type, e.g., IDE interfaces, or several types of connectors may be provided, e.g., Firewire, USB, Ethernet, and IDE interfaces all on the same hard drive caddy 100. Providing multiple connectors allows the HDD stored in hard drive caddy 100 to be accessible to multiple host systems without requiring that wires be disconnected and reconnected. Providing multiple types of connectors allows for hard drive caddy 100 to be used with different host systems, even when a particular host system does not support a particular type of connection.

In some embodiments, connecting hard drive caddy 100 to the host system is easier than connecting a hard drive to the host system. This result can be achieved through numerous approaches. In one embodiment, the second connector is easier to connect and disconnect than the traditional IDE interface, either because of an intentionally looser connection or by use of a more user-friendly interface, such as Firewire. In another embodiment, hard drive caddy 100 is designed to be used in conjunction with a separate unit, and can be inserted or removed from that unit as easily as a videocassette can be inserted or removed from a videocassette recorder.

In another embodiment, these two connectors provide some protection for the HDD inside hard drive caddy 100. In particular, the connectors may provide electric surge or short protection for the HDD. Incorporating elements known in the art, e.g., a circuit breaker, fuse, or similarly known anti-surge element, into the connection between the two connectors provides a safeguard for the data stored on the HDD inside hard drive caddy 100.

In another embodiment, hard drive caddy 200 omits both connectors, and instead includes opening 220 in housing 201 to provide direct access to the interface connectors on the HDD itself. A user can connect the HDD directly to the host system by inserting the standard connector through this window-like opening.

In this embodiment, hard drive caddy 100 includes securing elements 130. Connectors 130 serve to hold the HDD securely within hard drive caddy 100. In this embodiment, securing elements 130 are depicted as spring-loaded clips, and are positioned such that they will interface with the standardized screw holes in a 3.5 ″ HDD. In another embodiment, securing elements 130 are elastic straps. In another embodiment, securing elements 130 are screws. In other embodiments, securing elements 130 are different devices. In the embodiment of FIG. 2, no separate securing elements are used; instead, compartment 205 completely encloses the HDD in a tight-fitting space, preventing movement. The principal consideration is that the HDD be held securely in place within the hard drive caddy.

In this embodiment, hard drive caddy 100 is shown as including optional display 135. Display 135, in this embodiment, is a user-configurable LCD screen, which allows the user to, for example, label the hard drive caddy with the contents of the HDD. In other embodiments, different types of display 135 are included, and may display different sorts of information. In other embodiments, display 135 is omitted. In some embodiments, hard drive caddy 100 includes a label upon which the user may note the contents of the drive.

In this embodiment, hard drive caddy 100 is shown as including optional controls 137. Here, optional controls 137 are depicted as push buttons. In other embodiments, other types of controls are utilized, including, but not limited to, knobs, switches, sliders, and levers. The functions assigned to controls 137 differ by embodiment. In one embodiment, controls 137 are used to turn hard drive caddy 100, and the hard drive contained within, on or off. In another embodiment, controls 137 are used to connect and disconnect hard drive caddy 100 from the host system. In another embodiment, controls 137 provide interaction with display 135. In another embodiment, controls 137 allow the contents of the HDD within hard drive caddy 100 to be quickly erased. Other embodiments allow for different configuration of functions for controls 137. Other embodiments omit controls 137 entirely.

In one embodiment of the present invention, hard drive caddy 200 includes handle 235 attached to hard drive caddy 200. A handle, in one embodiment, allows for easier portability of hard drive caddy 200, with a reduced risk of dropping or otherwise damaging the HDD stored within hard drive caddy 200. In another embodiment, inclusion of a handle allows for easier removal of hard drive caddy 200 from an associated base unit, such as a hard drive enclosure or digital video recorder. In one embodiment, this handle is rigid. In another embodiment, a flexible handle is used. In one embodiment, the handle folds into a depression in housing 201 when not in use. In another embodiment, the handle is removable when not in use. In another embodiment, the handle may be retracted into housing 201. Other embodiments omit the handle entirely.

Configuration and Customization of a Hard Drive Caddy

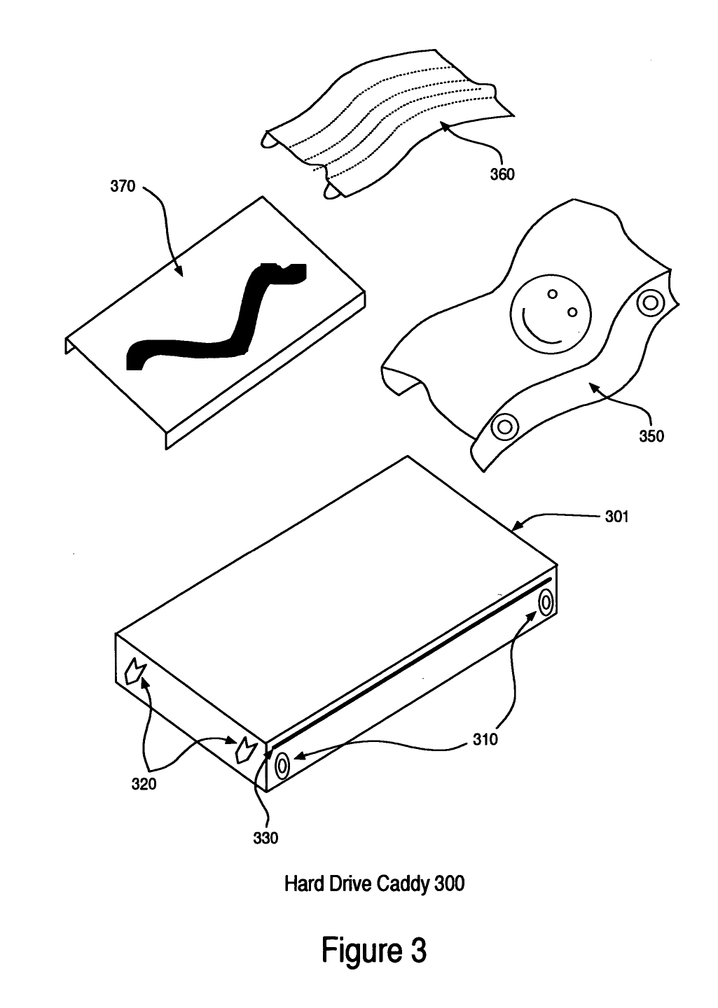

With reference now to FIG. 3, several embodiments are depicted showing methods of user customization of the appearance of hard drive caddy 300. Hard drive caddy 300 has a housing 301. Housing 301 incorporates several types of fasteners, including snaps 310, restraining clips 320, and insertion grooves 330 to aid in customization.

In one embodiment, housing 301 allows the user to configure a different appearance as desired. In one embodiment, this is accomplished through the use of “skins,” such as are known in the art for use with other electronic devices, including cell phones and portable music devices. Examples of skins include elastic fabrics and hard plastics, which are applied to hard drive caddy 300 in order to give it a different appearance. In another embodiment, housing 301 has an external surface selected for use with static-adhering stickers. In other embodiments, other methods of external decoration or customization are used. One consideration is to allow the user to self-customize his hard drive caddy 300.

One embodiment allows for a user to snap skin 350 onto hard drive caddy 300, through use of snaps 310. Another embodiment allows a user to stretch skin 360, formed of an elastic synthetic material, over restraining clips 320. Another embodiment allows the user to slide or lock skin 370, a hard plastic shell, into a groove 330 in housing 301 of hard drive caddy 300. Other embodiments support other methods of customization. Other embodiments omit this feature. One consideration is that other electronic devices allow for similar degrees of customization, making this a desirable feature.

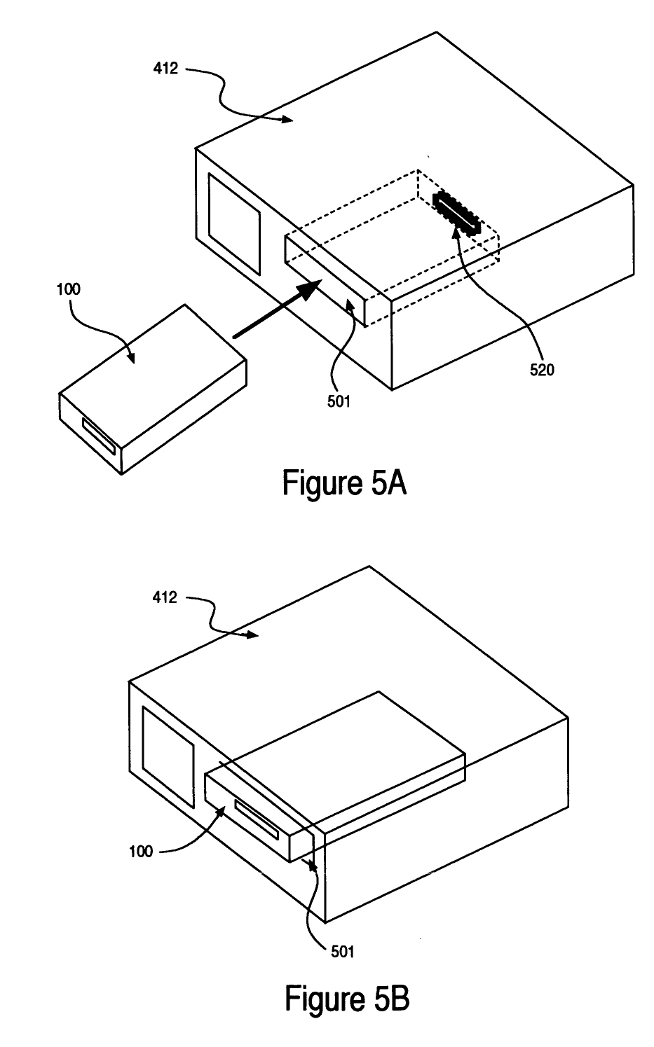

With reference now to FIGS. 5A and 5B, a hard drive caddy is shown in conjunction with a computer system, in accordance with one embodiment. In this embodiment, computer system 412, a media center computer, incorporates a slot 501. Hard drive caddy 100 can be easily inserted into and removed from slot 501. Slot 501 includes a connector 520 which interfaces with connector 120, when hard drive caddy 100 is inserted into slot 501. In this way, system 412 may communicate with and access data stored upon a data storage device within hard drive caddy 100. Insertion and removal of hard drive caddy 100, in this embodiment, is very similar to using a videocassette with a video cassette recorder. In other embodiments, other methods of coupling hard drive caddy to system 412 are utilized.

Embodiments of the present invention are thus described. While the present invention has been described in particular embodiments, it should be appreciated that the present invention should not be construed as limited by such embodiments, but rather construed according to the following claims.

What is claimed is:

1. A hard drive caddy for protecting a hard disk drive (HDD) and coupling to a host system, comprising:
a housing, defining a compartment of an appropriate size for receiving said HDD and configured to protect exposed components of said HDD;
a first connector, disposed within said housing, configured to couple with said HDD;
a second connector, coupled to said first connector, for interfacing with said host system; and
a mechanism holding said HDD securely within said compartment.

2. The hard drive caddy of claim 1, further comprising:
a protective element for protecting said HDD from physical damage.

3. The hard drive caddy of claim 1, further comprising:
expanded polystyrene material, disposed within said housing, configured to protect said HDD from physical damage.

4. The hard drive caddy of claim 1, further comprising:
a mechanical damping component, disposed within said housing, configured to protect said HDD from physical damage.

5. The hard drive caddy of claim 4, wherein said mechanical damping component comprises a spring.

6. The hard drive caddy of claim 4, wherein said mechanical damping component comprises a viscoelastic material.

7. A digital data storage device, comprising:
a data storage element for storing digital data;
a housing, at least partially enclosing said data storage element and configured to protect exposed elements of said data storage device;
a connector, coupled to said data storage element, for connecting said digital data storage device to a host system; and
a physical shock protection element, disposed within said housing, for protecting said data storage element from physical damage.

8. The digital data storage device of claim 7, further comprising an electric shock protection element.

9. The digital data storage device of claim 8, wherein said electric shock protection element comprises insulating material to protect said data storage element from electric shocks.

10. The digital data storage device of claim 8, wherein said electric shock protection element comprises conductive material configured to ground said digital data storage device.

11. The digital data storage device of claim 7, further comprising an electrical surge protection element.

12. The digital data storage device of claim 11, wherein said electrical surge protection element comprises a surge protector between said connector and said data storage element.

13. The digital data storage device of claim 11, wherein said electrical surge protection element comprises a fuse between said connector and said data storage element.

14. The digital data storage device of claim 7, further comprising a plurality of connectors for interfacing with multiple host systems simultaneously.

15. A system for accessing digital data on a removable storage device, said system comprising:
a host computer;
a base interface unit, coupled to said host computer; and
a removable storage device, removably coupleable to said base interface unit, comprising:
a protective housing;
a digital storage element, disposed at least partially within said protective housing; and
a communications interface coupled to said digital storage element;
wherein said digital storage element is configured to be readily coupled to and decoupled from said base interface unit, and wherein said digital storage device may be accessed by said host computer when it is coupled to said base interface unit.

16. The system of claim 15, wherein said removable storage device further comprises a user-customizable external skin.

17. The system of claim 16, wherein said user-customizable external skin comprises a hard plastic piece removably coupled to said protective housing.

18. The system of claim 15, wherein said removable storage device further comprises a handle.

19. The system of claim 15, wherein said host computer comprises a media center computer.

20. The system of claim 15, wherein said host computer is configured to record and playback digital media files.
